(19) United States
(12) Patent Application Publication
(10) Pub. No.: US 2014/0354448 A1
(43) Pub. Date: Dec. 4, 2014

(54) AUTOMATIC REMOTE INSTRUMENTATION COMMUNICATION

(71) Applicant: Cartasite, Inc., Denver, CO (US)

(72) Inventor: David L. Armitage, Golden, CO (US)

(73) Assignee: Cartasite, Inc., Denver, CO (US)

(21) Appl. No.: 14/286,741

(22) Filed: May 23, 2014

Related U.S. Application Data
(60) Provisional application No. 61/829,013, filed on May 30, 2013.
(60) Provisional application No. 61/903,190, filed on Nov. 12, 2013.

(51) Int. Cl. G08C 17/02

(52) U.S. Cl. CPC G08C 17/02
USPC 340/870.16

(57) ABSTRACT

Systems, software, and methods are provided for automatically communicating remote sensor information when a communication device is in range of the sensor(s) or other transmission source. Furthermore, the communication device may then communicate the information when the communication device enters into range of a data collection system.

### CROSS REFERENCE TO RELATED APPLICATIONS

This application claims priority to, and benefit from, provisional patent application Ser. No. 61/829,013, entitled “DYNAMIC QUICK RESPONSE CODE CREATION AND USE”, filed May 30, 2013, and provisional patent application Ser. No. 61/903,190, entitled “AUTOMATIC REMOTE INSTRUMENTATION COMMUNICATION”, filed Nov. 12, 2013, both of which are incorporated by reference for all purposes.

### TECHNICAL BACKGROUND

Many different individuals and companies are involved in monitoring and maintenance of oil wells, sites, systems, equipment, devices, and distribution units. These entities include the oil companies, and many different servicing companies, which service many different aspects of the sites.

Companies may also choose to monitor the systems, devices, locations, and/or equipment, etc. This monitoring typically includes drivers or operators recording, in paper form, the condition of the equipment. Such recording could include the flow rate, tank level, oil level, the pressure, the gas level, or any other information about the equipment or site. Communication from remote sensors may be limited in range at remote locations.

### Overview

Systems, software, and methods are provided for automatically communicating remote sensor information when a communication device is in range of the sensors or transmission system. Furthermore, the communication device may then communicate the information when the communication device enters into range of a data collection system.

### BRIEF DESCRIPTION OF THE DRAWINGS

FIG. 1 illustrates a monitoring system according to one example.

FIG. 2 illustrates a monitoring method according to one example.

FIG. 3 illustrates an operation of a monitoring system according to one example.

FIG. 4 illustrates an operation of a monitoring system according to one example.

FIG. 5 illustrates a monitoring computing environment according to one example.

### DESCRIPTION

Systems and methods are provided for improved monitoring systems. In at least one example, the system includes wireless sensors. These well sites may contain many devices, systems, and sensors. The sensor may transmit information when a monitoring device is in range. The sensors may also transmit information to a transmission site, which then transmits to a monitoring device when the monitoring device is within range.

The devices may also transmit information related to the device, system, location, sensed, information, etc. When a user arrives at the well site, the system may automatically transmit and receive information such as the identifier code of the various devices, sensed information, as well as any other information about the system using an monitoring device, such as a smart phone. Once the information is received by the smart phone, the data may then be transmitted to a central system that maintains information regarding all systems. Communications with the information may also be created and distributed.

In an example, the system includes equipment that needs to be monitored. This equipment could include trucks, machinery, or any other equipment that requires maintenance checks. In operation, a user device may be used to receive information about the maintenance of the equipment such as the fuel level, oil level, or any other useful maintenance information.

The sensing devices may also receive information from a user device such as a cell phone, tablet, or other device. The information may include the user's authorization level, as well as company, and information about what devices the user typically monitors. Then the devices and information which the user is authorized to receive may be identified and transmitted. The information may only include information the user is authorized to monitor.

Once the data is recorded, the data may then be transmitted to a central system that maintains information regarding all the equipment. The communications can include dynamically configurable reports, which include the information. The report may be based at least in part on the user, location, time, and/or the recorded information. The report may include billing information well as other information.

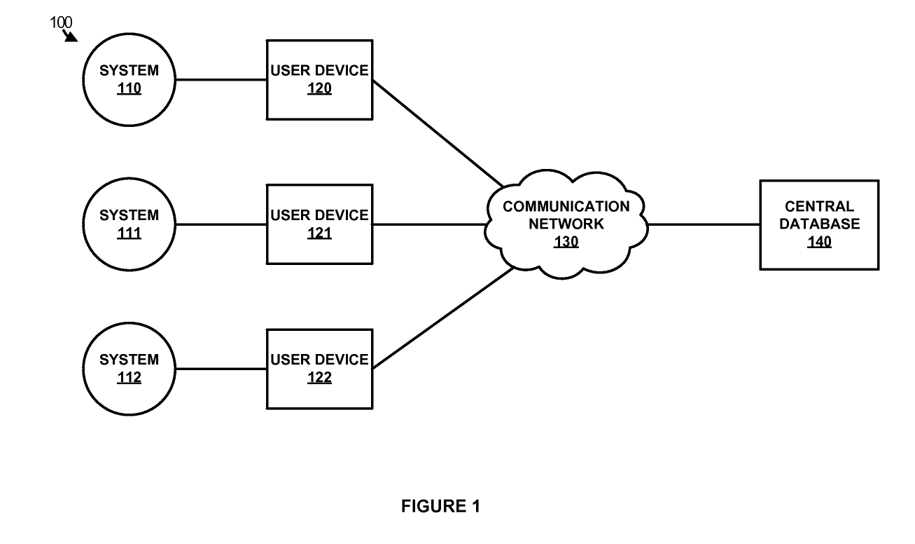

FIG. 1 illustrates a monitoring environment 100 according to one example. System 100 includes systems 110-112, user devices 120-122, communication network 130, and central database 140. In FIG. 1, user devices 120-122 record information about systems 110-112 then transmit this information to central database 140 through communication network 130.

In an example, systems 110-112 can include any object that can have associated information. These devices can include wells, sites, locations, tanks, valves, level sensors, etc. In another example, systems 110-112 can include trucks, cars, or any other mechanical equipment. The communication between systems 110-112 and user devices 120-122 may be wireless, and in some examples, a Bluetooth-type communication.

User devices 120-122 can include any objects capable of collecting information about systems 110-112. Devices 120-122 can include smart phones, tablets, or any other portable device capable of collecting information, including a monitoring system attached to a vehicle. The information collected may include information associated with the object such as the amount of oil or other product being transferred, the oil level of the equipment, flow, level, temperature, user inputs, pictures, as well as any other information about systems 110-112.

In an example, the user may be a service person for a well site. The user may have a cell phone with an application for Bluetooth-type communication and receiving sensed information. The application may use the GPS of the phone to determine the well site information where the user is located. A sensor with wireless communication capability may then identify the device and “pair” or enable communication with the user device. The sensor may then transmit information to the user device. This may happen generally automatically without the user initiating the process.

The communication between devices, a sending unit, and the user device may occur when the pieces are proximate. Blue-tooth communication may operate properly up to 1000 feet. The present system may operate when the user device and the sensor or sending unit is 0.1-1500 feet or more or less.

The user may also enter information via a user interface of the app, such as notes, observations, pictures, as well as non-automatic level information, flow information, etc. This may reduce the amount of information a user may need to enter, and may reduce the errors in recording and transcription of the data to various report, etc.

Communication network 130 can include the Internet, cellular, Wi-Fi, satellite, radio frequency (RF), or any other form of wires or wireless communication network between user devices 120-122 and central database 140, and can include cloud-type programs and devices. Central database 140 can include one or more server computers, desktop computers, or any other devices configured to store and track information received from user devices 120-122.

Central database 140 or associated processors may then populate fields of a dynamically configurable report. The report may be configurable by the user via user device, or at the central database 140, or by other devices and users. The report may be configurable based at least in part on the user, the task the user is attempting, and/or the information recorded, and/or any other information. The report may include billing information. The billing information may be communicated to a third party, such as a supervisor for approval before being sent to a client.

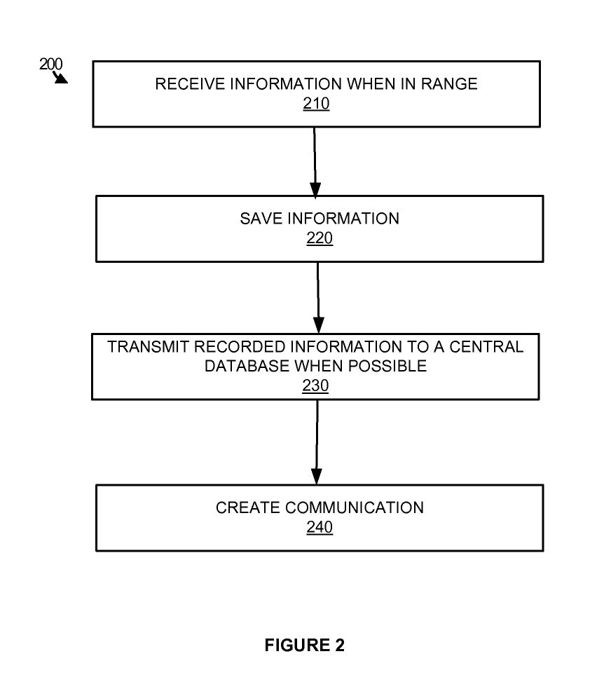

FIG. 2 illustrates a monitoring method 200 for monitoring systems, devices, locations, and/or equipment, etc. The method begins with a monitoring device receiving information relating to a sensor, location, etc. (210). The information may be transmitted to the monitoring device and may be activated when the monitoring device gets near enough to a sensor or other device.

A communication application may be initiated on the monitoring device to communicate with the sensors. Once the information is received, it may be stored on the monitoring device (220). This user device may include a smart phone, tablet computer, monitoring device attached to a vehicle, or any other device configured to wirelessly collect information from the systems, devices, locations, and/or equipment, etc.

In one example, other information may be recorded by the user such as the amount of oil transferred, pictures of the surrounding area, amount of time at the location, notes, observations, or any other information regarding the user's transaction at the system. Further, the monitoring device could record times and global positioning locations for the transactions.

Once the system or device information has been read and/or recorded, the collected information is transferred to a central database (230) to store and track the information from all of the systems when communication with the monitoring device is possible or desired.

In one example, the information gathered from the system could be transmitted after all the information is gathered. In situations where the communication network is unavailable, the information can be sent when the network becomes available. The site may be remote and satellite communication may be very expensive.

In another example, the information could be transmitted immediately as the information is gathered. In situations where the communication network is unavailable, the information can be sent when communication becomes possible. In another example, the collected information could be sent periodically to the central database over the communication network. In another example, the collected information could be requested by the central database.

Communications can then be created (step 240). The communications can include a dynamic job-specific report. The user may select fields to include in the report, including sensed information, other information, codes and user entries may be used to populate the fields with data. This may replace a “trip” sheet, gauge sheet, or other report in which this information is written down and tuned in at a central office.

The communication may also include sending this information in a report to a supervisor. It may also include creating a billing report to be sent to the client. This may reduce errors in hand writing information, and may reduce time to billing be automatically accomplishing this. This may also increase the reliability of the data and report as the user's location, and information about the system will be more accurate than the user filling out a paper form. Furthermore, the sensed data may be transmitted relatively automatically when any authorized person in in the area. This may create more information about the site, which may be valuable.

Although the example transaction method is an oil transaction method, it should be understood that the method could apply to any situation that uses generally automatically transmitted wireless data to monitor systems. Additionally, it should be understood that the order of events in method 200 could be rearranged and/or accomplished concurrently.

The system may receive information from a monitoring device such as a cell phone, tablet, or other device. The information may include the user's authorization level, as well as company, and information about what devices the user typically monitors. The information may be identified and transmitted to the monitoring device. The information may only include information the user is authorized to monitor. The information may be transmitted to a data system when appropriate.

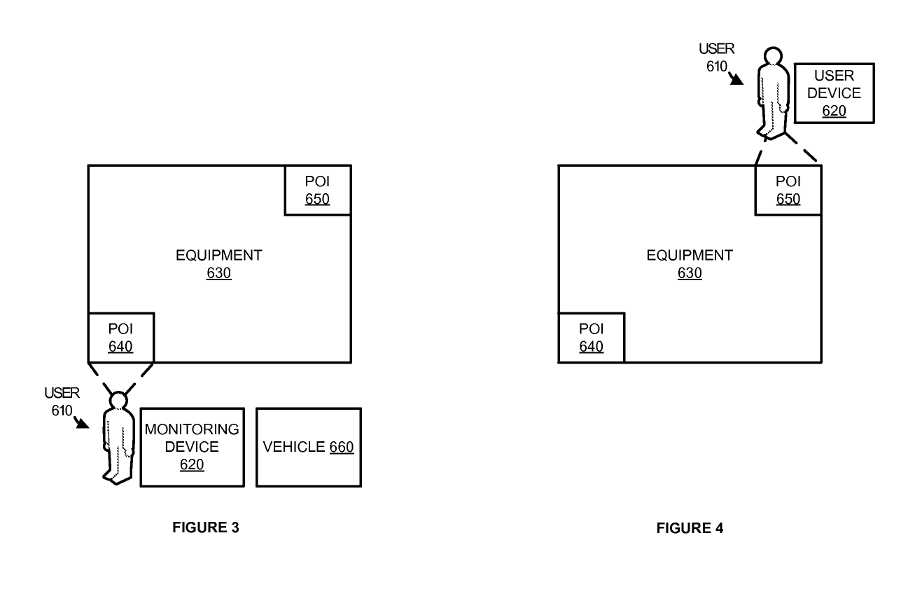

FIGS. 3 and 4 illustrate an example operation of the monitoring system. In FIGS. 3 and 4, rather than recording information about a system and/or object, the user device/monitoring device may be configured to record the status of, or information relating to, the device including the oil or water level of the equipment, the tire pressure of the equipment, the flow, the position of a valve, information about the well or site, or any other information about the equipment. The equipment could include trucks, machinery, tanks, valves, wells, pumps, or any other equipment used to perform a task. FIGS. 3 and 4 include user 610, user device 620, equipment 630, and points of interest 640-650 (POI). The information may be automatically transmitted from various devices adjacent POI 640, 650 to the monitoring or user device 620.

Monitoring device 620 may be a smart phone, and/or other device, including a device adjacent vehicle 660. The device adjacent the vehicle 660 may be plugged in to the OBD port of the vehicle and may be capable of receiving wireless information from sensors and/or devices. The other device may also be capable of transmitting the information to a central database as described in FIG. 1.

Device adjacent vehicle 660 may also be capable of receiving information from sensors and locations, and transmitting the information to the central database.

In operation, user 610 may initiate a communication/recording application on user device 620. This recording application can allow user device 620 to receive information about equipment 630 including wireless sensor information, an identifier of equipment 630 and information about points of interest 640, 650. Points of interest 640, 650 can include a pump, tank, valve, level, flow, the tires, or any other point of interest on the equipment.

POIs 640, 650 may also include a system for receiving information from a user device such as a user identifier, authorization level, company, and type of monitoring being accomplished. The system at POIs 640, 650 may also include circuitry and/or computing system capable of identifying and transmitting information the user is authorized to receive.

As can be seen in FIG. 3, user 610 receives/records information from and about point of interest 640. This information may include wireless sensor information, other information, a barcode, a QR code, a name, a number, or any other information related to point of interest 640. Further, the application on user device 620 may allow user 610 to input information such as notes, observations, the tank level, flow rate, amount of flow for a period of time, the tire pressure, or any other information about point of interest 640 and/or the user. The application may also allow user 610 to take pictures of equipment 630 and point of interest 640, which may be recorded information about POI 640, 650.

Next, after recording/receiving information about point of interest 640, user 610 may then proceed to record information about another point of interest 650 (FIG. 4). This information may include wireless sensor information, other information, a barcode, a QR code, a name, a number, or any other information related to point of interest 650. Further, the application on user device 620 may allow user 610 to input information such as the oil level, the tire pressure, or any other information about point of interest 650. The application may also allow user 610 to take pictures of equipment 630 and point of interest 650. It should be understood that although FIGS. 3 and 4 include two points of interest, any number of points of interest could be recorded by the system.

In one example, user device 620 could gather other information such as the identity of the user device, the global positioning location of the user device, date and time, the amount of time to record the information about all of the points of interest, the amount movement by the user in recording the information about the points of interest, information regarding the POI 640, 650, pictures of the equipment, and/or service needed at the POI 640, 650, user inputs, or any other information about equipment 630.

Once information is gathered by user device 620, user device 620 may then transfer the information to a central database using a communication network such as the Internet, satellite, RF, or a cellular network. The central database may then store all of the data about equipment 630, as well as any other data about equipment sent from similar user devices.

The central database or other system may then create, populate, and transmit a dynamic and possibly job-specific report. The report may be based on the user information from the cell phone. This information may include the type of service to be accomplished by the user is at the systems and devices. The report may also be based on the type of information collected, such as if the user collects information about water tank levels, then the report may include data about the water system, and prompt the user for all information needed, such that the user may not omit needed information.

In one example, the user may be unaware the information has been received and transmitted. Other reports may be generated in this example.

One report may include specifics of the particular transaction, such as tank levels and flow rates. This report may be sent to a supervisor for approval, then on to a client. Another report may be an invoice for the service, and may include some of the information collected, along with billing and payment information. This report may also be sent to a supervisor for approval, or may be automatically sent based on the supervisor's approval of the first report.

The user or other person may be able to dynamically create a report or report type. Different fields may be included or excluded in almost real-time. In this manner, a customized repot may be accomplished and different reports and information may be included for different wells, clients, systems, devices, POIs, etc.

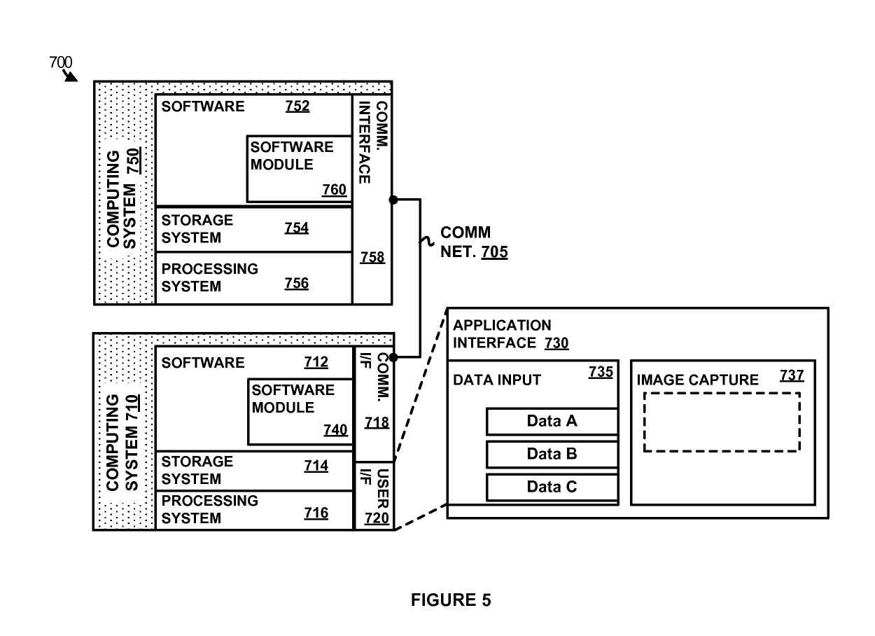

FIG. 5 illustrates a monitoring computing environment 700 according to one example. In an example, computing environment 700 includes computing system 710 and computing system 750. Computing system 710, in the present example, corresponds to user device 120 and/or device adjacent vehicle 660, and computing system 750 corresponds to central database 140 and/or the system at POIs 640, 650 capable of receiving information about the monitoring device. The system may also be capable of communicating with wireless sensing devices.

Computing system 710 can include any smart phone, tablet computer, laptop computer, computing device, or other device capable of reading, and/or recording data about systems, devices, locations, and/or equipment, etc. Computing system 750 can include any server computer, desktop computer, laptop computer, or other device capable of storing and managing the data collected by computing system 710 or other similar computing systems, and/or operating as a computing system adjacent POIs 640, 650.

In FIG. 5, computing system 710 includes processing system 716, storage system 714, software 712, communication interface 718, and user interface 720. Processing system 716 loads and executes software 712 from storage system 714, including software module 740. When executed by computing system 710, software module 740 directs processing system 716 to receive data systems, devices, locations, and/or equipment, etc. Such data could include any of the information described above. Although computing system 710 includes one software module in the present example, it should be understood that one or more modules could provide the same operation.

Additionally, computing system 710 includes communication interface 718 that can be further configured to transmit the collected data to computing system 750 using communication network 705. Communication network 705 could include the Internet, cellular network, satellite network, RF communication, blue-tooth type communication or any other form of wired or wireless communication network capable of facilitating communication between computing systems 710, 750. In some examples, communication interface 718 can further include a global positioning system to determine the location of computing system 710. Furthermore, communication interface 718, 758 is capable of sending and receiving information to and from sensors capable of transmitting and receiving information wirelessly, such as via a Bluetooth-type communication.

Referring still to FIG. 5, processing system 716 can comprise a microprocessor and other circuitry that retrieves and executes software 712 from storage system 714. Processing system 716 can be implemented within a single processing device but can also be distributed across multiple processing devices or sub-systems that cooperate in executing program instructions. Examples of processing system 716 include general purpose central processing units, application specific processors, and logic devices, as well as any other type of processing device, combinations of processing devices, or variations thereof.

Storage system 714 can comprise any storage media readable by processing system 716, and capable of storing software 712. Storage system 714 can include volatile and nonvolatile, removable and non-removable media implemented in any method or technology for storage of information, such as computer readable instructions, data structures, program modules, or other data. Storage system 714 can be implemented as a single storage device but may also be implemented across multiple storage devices or sub-systems. Storage system 714 can comprise additional elements, such as a controller, capable of communicating with processing system 716.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

User interface 720 can include a mouse, a keyboard, a camera, a Barcode scanner, a QR scanner, a voice input device, a touch input device for receiving a gesture from a user, a motion input device for detecting non-touch gestures and other motions by a user, and other comparable input devices and associated processing elements capable of receiving user input from a user. These input devices can be used for defining data about the systems, devices, locations, and/or equipment, etc. Output devices such as a graphical display, speakers, printer, haptic devices, and other types of output devices may also be included in user interface 720. The aforementioned user input and output devices are well known in the art and need not be discussed at length here. In some examples, computing system 710 can include an accelerometer to track the movement of the user around the systems and POIs.

Application interface 730 can include data input 735 and image capture 737. In one example, data input 735 can be used to collect information regarding a distribution item such as the identifier of the distribution item, the seal tag identifiers, the amount of oil being transferred, or any other information about the system. In another example, data input 735 can be used to collect information about mechanical equipment such as oil level, tire pressure, or any other information about the equipment.

Further, application interface 730 could include image capture 737 that could be used to receive input such as QR Codes and Barcodes to identify information about systems, devices, locations, and/or equipment, etc. It should be understood that although computing system 710 is shown as one system, the system can comprise one or more systems to collect data.

Computing system 750 includes processing system 756, storage system 754, software 752, and communication interface 758. Processing system 756 loads and executes software 752 from storage system 754, including software module 760. When executed by computing system 750, software module 760 directs processing system 710 to store and manage the data from computing system 710 and other similar computing systems.

Although computing system 710 includes one software module in the present example, it should be understood that one or more modules could provide the same operation.

Additionally, computing system 750 includes communication interface 758 that can be configured to receive the data from computing system 710 using communication network 705. Furthermore, communication interface 718, 758 is capable of sending and receiving information to and from sensors capable of transmitting and receiving information wirelessly, such as via a Bluetooth-type communication.

Referring still to FIG. 5, processing system 756 can comprise a microprocessor and other circuitry that retrieves and executes software 752 from storage system 754. Processing system 756 can be implemented within a single processing device but can also be distributed across multiple processing devices or sub-systems that cooperate in executing program instructions. Examples of processing system 756 include general purpose central processing units, application specific processors, and logic devices, as well as any other type of processing device, combinations of processing devices, or variations thereof.

Storage system 754 can comprise any storage media readable by processing system 756 and capable of storing software 752 and data from computing system 710. Data from computing system 710 may be stored in a word, excel, or any other form of digital file. Storage system 754 can include volatile and nonvolatile, removable and non-removable media implemented in any method or technology for storage of information, such as computer readable instructions, data structures, program modules, or other data. Storage system 754 can be implemented as a single storage device but may also be implemented across multiple storage devices or sub-systems. Storage system 754 can comprise additional elements, such as a controller, capable of communicating with processing system 756.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

In some examples, computing system 750 could include a user interface The user interface can include a mouse, a keyboard, a voice input device, a touch input device for receiving a gesture from a user, a motion input device for detecting non-touch gestures and other motions by a user, and other comparable input devices and associated processing elements capable of receiving user input from a user. Output devices such as a graphical display, speakers, printer, haptic devices, and other types of output devices may also be included in the user interface. The aforementioned user input and output devices are well known in the art and need not be discussed at length here.

It should be understood that although computing system 750 is shown as one system, the system can comprise one or more systems to store and manage received data.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A monitoring method, the method comprising;
receiving information from a sensing device by a monitoring device, generally automatically, when the monitoring and the sensing device are proximate; and
transmitting the received information to a data collection system by the monitoring device when a communication path is available between the monitoring device and the data collection system.

2. The method of claim 1, wherein the sensing device and the monitoring device communicate at least in part via a Bluetooth-type communication.

3. The method of claim 1, wherein the communication path between the monitoring device and the central database comprises a cellular, satellite, Wi-Fi, wired, wireless, near field, or radio frequency-type communication path.

4. The method of claim 1, wherein the proximate distance is generally about 0.1-1500 feet between the sensing device and the monitoring device.

5. The method of claim 1, wherein the transmitting comprises transmitting the received information to a cloud-based application.

6. The method of claim 1, wherein the received information is used to create a report.

7. The method of claim 6, wherein the report is transmitted to a third party.

8. The method of claim 1, wherein the monitoring device comprises a personal communication device.

9. The method of claim 8, wherein the personal communication device comprises a cellular telephone.

10. The method of claim 1, wherein generally automatically comprises no user input to the monitoring device.

11. A computer readable medium, having stored thereon instructions, which if executed by a processor, cause the processor to:
receive information from a sensing device by a monitoring device, generally automatically, when the monitoring and the sensing device are proximate at least in part via wireless communication; and
transmitting the received information to a central database by the monitoring device when a communication path is available between the monitoring device and the central database,
wherein the communication path comprises a cellular network communication path.

12. The computer readable medium of claim 11, wherein wireless communication comprises a Bluetooth-type communication.

13. The computer readable medium of claim 11, wherein the communication path between the monitoring device and the central database comprises a satellite, Wi-Fi, or radio frequency-type communication path.

14. The computer readable medium of claim 11, wherein the proximate distance is generally about 1-1200 feet between the sensing device and the monitoring device.

15. The computer readable medium of claim 11, wherein the transmitting comprises transmitting the received information to a cloud-based application.

16. The computer readable medium of claim 11, wherein the received information is used to create a report and the report is sent to a third party.

17. The computer readable medium of claim 11, wherein monitoring device comprises a cellular telephone.

18. The computer readable medium of claim 11, where the sensing device is capable of creating information about a sensed item.

19. A system for automatically retrieving remote data, comprising a monitoring device, the computing device comprising:
a receiving module configured to receive information from a sensing device by the monitoring device, generally automatically, when the monitoring and the sensing device are proximate at least in part via wireless communication; and
a transmitting module configured to transmit the received information to a data collection system by the monitoring device when a communication path is available between the monitoring device and the data collection system,
wherein the communication path between the monitoring device and the central database comprises a cellular, satellite, Wi-Fi, wired, wireless, near field, or radio frequency-type communication path,
wherein generally automatically comprises no user input to the monitoring device.

20. The system of claim 19, wherein wireless communication comprises a Bluetooth-type communication.
